(19) United States
(12) Patent Application Publication
(10) Pub. No.: US 2014/0300031 A1
(43) Pub. Date: Oct. 9, 2014

(54) BINDER SYSTEM BASED ON POLYURETHANE FOR PRODUCING CORES AND CASTING MOLDS USING CYCLIC FORMALS, MOLDING MATERIAL MIXTURE, AND METHOD

(71) Applicants: Christian Priebe, Wulfrath (DE); Diether Koch, Mettmann (DE)

(72) Inventors: Christian Priebe, Wulfrath (DE); Diether Koch, Mettmann (DE)

(73) Assignee: ASK CHEMICALS GMBH, Hilden (DE)

(21) Appl. No.: 13/813,062

(22) PCT Filed: Jul. 28, 2011
(86) PCT No.: PCT/DE2011/001525

§ 371 Date: Apr. 8, 2013

(30) Foreign Application Priority Data
Jul. 30, 2010 (DE) 102010032734.4

(51) Int. Cl. C08K 5/1575; C08K 3/36; C08J 5/00

(52) U.S. Cl. CPC C08K 5/1575; C08J 5/00; C08K 3/36; C08J 2361/14
USPC 264/232; 524/108; 264/334

(57) ABSTRACT

A binder system for a molding mixture has at least one phenolic resin component, at least one isocyanate component and at least one solvent component, where the at least one solvent component is a cyclic formal, also known as a cyclic formaldehyde, with or without additional solvents. The phenolic resin component is prepared by reacting a phenol compound with an aldehyde compound. The isocyanate component has at least polyisocyanate that has at least two isocyanate groups per molecule. In the molding mixture, the binder is combined with a refractory molding material.

The present invention relates to a binder system for producing cores and casting molds based on polyurethane using cyclic formals, a molding material mixture containing the binder, and a method for producing casting molds using the binder.

The known method for producing cores, referred to as the “cold-box method” or the “Ashland method” has attained great importance in the foundry industry. In this method, two-component polyurethane systems are used for binding a basic refractory molding material. The polyol component consists of a polyol having at least two OH groups per molecule, and the isocyanate component consists of a polyisocyanate having at least two NCO groups per molecule. The binder system is cured with the help of basic catalysts. Liquid bases may be added to the binder system prior to molding, to bring the two components to reaction (U.S. Pat. No. 3,676,392). It is further possible to conduct gaseous tertiary amines through the molding material/binder system mixture after molding (U.S. Pat. No. 3,409,579).

According to U.S. Pat. No. 3,676,392 and U.S. Pat. No. 3,409,579, phenolic resins are used as polyols, which are obtained by condensation of phenol with aldehydes, preferably formaldehyde, in liquid phase at temperatures up to approximately 130° C. in the presence of catalytic quantities of metal ions. U.S. Pat. No. 3,485,797 describes the production of such phenolic resins in detail. In addition to unsubstituted phenol, substituted phenols, preferably o-cresol and p-nonylphenol, can be used (see, e.g., U.S. Pat. No. 4,590,229). As additional reaction components, according to EP 0177871 A2, phenolic resins modified with aliphatic monoalcohol groups having one to eight carbon atoms can be used. As a result of alkoxylation, the binder systems should have increased thermal stability. As a solvent for the polyol component, predominantly mixtures of high-boiling polar solvents (e.g., esters and ketones) and high-boiling aromatic hydrocarbons are used. In contrast, the polyisocyanates are preferably dissolved in high-boiling aromatic hydrocarbons.

EP 0771599 A1 and WO 00/25957 A1 describe formulations in which aromatic solvents can be entirely or at least largely dispensed with by using fatty acid esters.

From U.S. Pat. No. 4,051,092, polyurethane systems are known in which epoxy resins, polyester resins or aqueous phenol formaldehyde resins are reacted with diisocyanates in the presence of a solvent of the formula

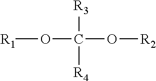

In which R₁ and R₂ denote hydrocarbons having 3 to 6 carbons and R₃ and R₄ denote methyl, ethyl, phenyl or hydrogen. Expressly specified are dibutoxymethane, dipropxymethane, diisobutoxymethane, dipentyloxymethane, dihexyloxymethane, dicyclohexyloxymethane, n-butoxyisopropoxymethane, isobutoxybutoxymethane and isopropoxypentyloxymethane, acetaldehyde-n-propyl acetal, benzaldehyde-n-butyl acetal, acetaldehyde-n-butyl acetal, acetone-di-n-butyl ketal and acetophenone-dipropyl ketal. In the examples, the ketal butylal (1-(butoxymethoxy)butane) is used. U.S. Pat. No. 4,116,916 and U.S. Pat. No. 4,172,068 have a similar disclosure content.

The use of diacetalene, specifically conversion products of C₂ to C₆ dialdehydes and C₂ to C₁₂ alcohols, in polyurethane systems is disclosed in WO 2006/092716 A1. Listed as diacetals are 1,1,2,2-tetramethoxyethane, 1,1,2,2-tetraethoxyethane, 1,1,2,2-tetrapropoxyethane, 1,1,3,3-tetramethoxypropane, and 1,1,3,3-tetraethoxypropane. It was determined that the diacetals enable an extension of the processing time of the molding material mixtures. However, this has a substantially disadvantageous effect on the stability of the fresh mixtures (“shoot immediate”). The loss in stability in relation to the unmodified binder is approximately 15% to approximately 20%.

For most applications, the strength of cores and molds produced with the known polyurethane binders is high enough by far.

Nevertheless, there is great interest in increasing strength levels further in order to lower the binder content, without strength losses if at all possible, i.e., without dropping below the level that is necessary for good casting and safe handling. There are several reasons for reducing the amount of binder, e.g., to reduce the amount of gases and condensates that are produced during casting, which can result in casting defects and can pollute the environment. Moreover, a low binder content reduces the cost of regenerating the old sand, and, not least, foundries are interested in using the smallest possible amount of binder for commercial reasons.

In terms of strength levels, it is important above all to ensure adequate initial strength levels, particularly when the cores will be assembled immediately after production in (partially) automated facilities to form complex core packages or will be placed in permanent metallic molds.

The problem addressed by the invention was therefore that of providing a molding material mixture with which molded articles for the foundry industry can be produced, which have higher initial strength levels than molded articles that have been produced from a molding material mixture that is provided with a conventional binder, e.g., at least 10% higher initial strength levels. It has been found that said molding material mixture can be used to lower the binder content by approximately 5 to 10%, while simultaneously producing cores having sufficiently high strength levels for reliable handling, even in industrial series production.

This problem has been solved with the embodiment according to patent claim 1. Advantageous embodiments are the subject matter of the dependent patent claims or are described in what follows.

The subject matter of the invention is a binder for molding material mixtures, containing
(A) at least one polyol component having a polyol with at least two OH groups per molecule, wherein the polyol component comprises at least one phenolic resin, and
(B) at least one isocyanate component having a polyisocyanate with at least two NCO groups per molecule and
(C) at least one cyclic formal according to claim 1.

The invention further relates to molding material mixtures which comprise basic refractory molding materials and up to 5 wt %, preferably up to 4 wt %, particularly preferably up to 3 wt % of the binder system according to the invention, referred to the weight of the basic refractory molding materials. Suitable refractory materials include quartz ore sand, zirconium ore sand, or chromium ore sand, olivine, chamotte and bauxite, for example. Synthetically produced basic molding materials can also be used, such as aluminum silicate hollow spheres (so-called microspheres), glass beads, glass granules, or the spherical ceramic molding materials known as “cerabeads” or “carboaccucast”. Mixtures of the above-stated refractory materials are also possible.

The invention also relates to a method for producing a casting mold piece or a core, comprising the steps of
(a) mixing refractory materials with the binder system according to the invention in a binding quantity of 0.2 to 5 wt %, preferably 0.3 to 4 wt %, particularly preferably 0.4 to 3 wt %, referred to the quantity of refractory materials, to obtain a casting mixture;
(b) placing the casting mixture obtained in step (a) in a mold;
(c) hardening the casting mixture in the mold to obtain a self-supporting casting mold piece; and
(d) Then separating the hardened casting mixture from the mold and hardening it further, if necessary, to obtain a hard, solid, cured casting mold piece.

Surprisingly, it has been found that the use of cyclic formals as part of the binder formulation has a positive effect on strength levels. The relative increase in strength levels, particularly of initial strength levels, is particularly pronounced in binder formulations that have a reduced proportion of phenolic resin in the polyol component. As a further advantage, it has been found that the cyclic formals improve the low-temperature resistance of the binder component.

The polyol component comprises phenol-aldehyde resins, shortened here to phenolic resins. Any conventionally used phenol compounds are suitable for producing the phenolic resins. In addition to unsubstituted phenols, substituted phenols or mixtures thereof can be used. The phenol compounds are preferably unsubstituted either in both ortho positions or in one ortho position and in the para position. The remaining cyclic carbon atoms may be substituted. The choice of substituents is not specifically limited, as long as the substituent does not adversely affect the reaction of the phenol with the aldehyde. Examples of substituted phenols include alkyl substituted, alkoxy substituted, aryl substituted and aryloxy substituted phenols.

The above-stated substituents have, for example, 1 to 26, preferably 1 to 15 carbon atoms. Examples of suitable phenols include o-cresol, m-cresol, p-cresol, 3,5-xylenol, 3,4-xylenol, 3,4,5-trimethylphenol, 3-ethylphenol, 3,5-diethylphenol, p-butylphenol, 3,5-dibutylphenol, p-amylphenol, cyclohexylphenol, p-octylphenol, p-nonylphenol, cardanol, 3,5-dicyclohexylphenol, p-crotylphenol, p-phenylphenol, 3,5-dimethoxyphenol and p-phenoxyphenol.

Phenol itself is particularly preferred. Higher condensed phenols, such as bisphenol A, are also suitable. Moreover, polyvalent phenols having more than one phenolic hydroxyl group are also suitable. Preferred polyvalent phenols have 2 to 4 phenolic hydroxyl groups. Specific examples of suitable polyvalent phenols include pyrocatechol, resorcinol, quinol, pyrogallol, phloroglucinol, 2,5-dimethylresorcinol, 4,5-dimethylresorcinol, 5-methylresorcinol or 5-ethylresorcinol. Mixtures of various monovalent and polyvalent and/or substituted and/or condensed phenol components can also be used for producing the polyol component.

In one embodiment, phenols of the general formula I:

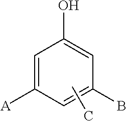

are used to produce the phenolic resin component, wherein A, B and C are chosen independently of one another from: a hydrogen atom, a branched or unbranched alkyl group, which can have 1 to 26, for example, preferably 1 to 15 carbon atoms, a branched or unbranched alkoxy group, which can have 1 to 26, for example, preferably 1 to 15 carbon atoms, a branched or unbranched alkenoxy group, which can have 1 to 26, for example, preferably 1 to 15 carbon atoms, an aryl group or alkylaryl group, such as biphenyls, for example.

As the aldehyde for producing the phenolic resin component, aldehydes of the formula:

R—CHO

are suitable, in which R denotes a hydrogen atom or a carbon atom group, preferably with 1 to 8, particularly preferably 1 to 3 carbon atoms. Specific examples include formaldehyde, acetaldehyde, propionaldehyde, furfurylaldehyde, and benzaldehyde. Particularly preferably, formaldehyde is used, either in its aqueous form, as paraformaldehyde, or trioxan.

To obtain the phenolic resins, an at least equivalent number of moles of aldehyde, referred to the number of moles of the phenolic component, is preferably used. The molar ratio of aldehyde to phenol is preferably 1:1.0 to 2.5:1, particularly preferably 1.1:1 to 2.2:1, most particularly preferably 1.2:1 to 2.0 to 1.

The phenolic resin is produced according to the method known to persons skilled in the art. In this method, the phenol and the aldehyde are combined under substantially anhydrous conditions, particularly in the presence of a divalent metal ion, at temperatures of preferably less than 130° C. The resulting water is removed by distillation. For this purpose, a suitable entraining agent can be added to the reaction mixture, for example, toluene or xylene, or the distillation is carried out at reduced pressure.

The phenolic resin is chosen such that curing with the polyisocyanate component is possible. To build up a network, phenolic resins that comprise molecules having at least two hydroxyl groups per molecule are necessary.

Particularly suitable phenolic resins are known under the name “ortho-ortho” or “high-ortho” novolacs or benzyl ether resins. These are obtainable by condensation of phenols with aldehydes in a weakly acid medium, using suitable catalysts. Catalysts suitable for producing benzyl ether resins include salts of divalent ions of metals, such as Mn, Zn, Cd, Mg, Co, Ni, Fe, Pb, Ca and Ba. Zinc acetate is preferably used. The quantity used is not critical. Typical quantities of metal catalyst are 0.02 to 0.3 wt %, preferably 0.02 to 0.15 wt %, referred to the total quantity of phenol and aldehyde.

Such resins are described, for example, in U.S. Pat. No. 3,485,797 and in EP 1137500 B1, the disclosure of which is herewith expressly referenced both with respect to the resins themselves and with respect to the production thereof.

The phenolic resin component and/or the isocyanate component of the binder system is preferably used as a solution in an organic solvent or a combination of organic solvents. Solvents can be necessary, for example, for keeping the components of the binder in a sufficiently low-viscous state. This is necessary, for example, in order to obtain a uniform wetting of the refractory molding material and the flowability thereof.

The isocyanate component of the binder system comprises an aliphatic, cycloaliphatic or aromatic polyisocyanate, preferably having 2 to 5 isocyanate groups per molecule. Depending on the desired properties, mixtures of isocyanates can also be used.

Suitable polyisocyanates include aliphatic polyisocyanates, for example, hexamethylene diisocyanate, alicyclic polyisocyanates, for example, 4,4′-dicyclohexylmethane diisocyanate and dimethyl derivatives thereof. Examples of suitable aromatic polyisocyanates include toluene-2,4-diisocyanate, toluene-2,6-diisocyanate, 1,5-naphthalene diisocyanate, triphenylmethane triisocyanate, xylylene diisocyanate and methyl derivatives thereof, along with polymethylene polyphenyl isocyanates. Particularly preferred polyisocyanates include aromatic polyisocyanates, with polymethylene polyphenyl polyisocyanates, for example, industrial 4,4′-diphenylmethane diisocyanate, i.e., 4,4′-diphenylmethane diisocyanate having a ratio of isomers and higher homologues, being particularly preferred.

In general, 10 to 500 wt % polyisocyanate component referred to the weight of the polyol component are used, preferably 20 to 300 wt %.

Up to 80 wt % of the isocyanate component can consist of solvent. As solvents for the polyisocyanate, either aromatic solvents, the above-stated polar solvents, or mixtures thereof are used. Fatty acid esters and silicic acid esters are also suitable.

The quantity of polyisocyanate used is preferably such that the number of isocyanate groups amounts to 80 to 120%, referred to the number of free hydroxyl groups of the resin.

According to the invention, the polyurethane binder obtains at least a portion of a cyclic formal. Cyclic formals can be obtained, for example, by reacting diols with formal. As long as said formal has no (free) OH functionality, the cyclic formal can be added to the phenolic resin component or to the isocyanate component, or to both.

The cyclic formals can be represented particularly by the following general formula:

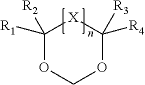

wherein
X denotes —C(R₅)(R₆)— or —R₇—O—R₈—
n denotes 0 to 4 and
R₁ to R₆ independently denote H or a hydrocarbon group, particularly an alkyl group, having 1 to 6 C atoms, wherein the hydrocarbon group can contain one or more ether groups and/or one or more ester groups, and/or can be substituted with a carbonyl and/or OH group, and
R₇ and R₈ independently denote a methylene, ethylene or propylene group.

Examples of cyclic formals include ethylene glycol formal, propylene glycol formal, diethylene glycol formal, 1,2-butanediol formal, 1,3-butanediol formal, 1,4-butanediol formal, neopentylglycol formal, glycerin formal (mixture of 5-hydroxy-1,3-dioxane and 4-hydroxymethyl-1,3-dioxolan), pentaerythritol formal, and 5-ethyl-5-hydroxymethyl-1,3-dioxane. 5-ethyl-5-hydroxymethyl-1,3-dioxane is preferred.

It is not necessary to use the cyclic formal with high purity; instead, commercially available mixtures that contain a certain portion of cyclic formal, such as 5-ethyl-5-hydroxymethyl-1,3-dioxane, can also be used. One example of such a mixture is polyol TD, in which the formal is present up to 25 to 60%, in addition to 2-ethyl-1,3-propanediol and trimethylolpropane.

The cyclic formal can be used as a solvent along with additional solvents. Suitable for this purpose are all solvents that are conventionally used in binder systems for foundry technology.

As solvents for the phenolic resin component, in addition to aromatic solvents, oxygen-rich polar, organic solvents can also be used. Suitable for this purpose are particularly dicarboxylic acid esters, glycolether esters, glycol diesters, glycol diethers, cyclic ketones, cyclic esters (lactone), cyclic carbonates or silicic acid esters. Dicarboxylic acid esters, cyclic ketones and cyclic carbonates are preferably used.

Dicarboxylic acid esters have the formula R₁OOC—R₂—COOR₁, wherein R₁ in each case independently denotes an alkyl group having 1 to 12, preferably 1 to 6, carbon atoms, and R₂ denotes an alkylene group having 1 to 4 carbon atoms. Examples include dimethyl esters of carboxylic acids having 4 to 6 carbon atoms, which are available, for example, under the name dibasic esters from DuPont.

Glycolether esters are compounds of the formula R₃—O—R₄—OOCR₅, in which R₃ denotes an alkyl group having 1 to 4 carbon atoms, R₄ is an alkylene group having 2 to 4 carbon atoms, and R₅ is an alkyl group having 1 to 3 carbon atoms, e.g., butyl glycol acetate, with glycol ether acetates being preferred.

Glycol diesters accordingly have the general formula R₃COO—R₄—OOCR₅, wherein R₃ to R₅ are as defined above, and the groups are each selected independently of one another (e.g., propylene glycol diacetate). Glycol diacetates are preferred. Glycol diethers can be characterized by the formula R₃—O—R₄—O—R₅, in which R₃ to R₅ are as defined above and the groups are each selected independently of one another (e.g., dipropylene glycol dimethylether).

Cyclic ketones, cyclic esters and cyclic carbonates having 4 to 5 carbon atoms are also suitable (e.g., propylene carbonate). The alkyl and alkylene groups can each be branched or unbranched.

Also suitable are fatty acid esters, such as rapeseed oil fatty acid methyl esters and oleic acid butyl ester.

In addition to the above-mentioned constituents, the binder systems can also contain additives, e.g., silanes (e.g., according to EP 1137500 B1) or internal release agents, e.g., fatty alcohols (e.g., according to U.S. Pat. No. 4,602,069), drying oils (e.g., according to U.S. Pat. No. 4,268,425) or complexing agents (e.g., according to U.S. Pat. No. 5,447,968), or mixtures thereof.

Suitable silanes include, for example, aminosilanes, epoxysilanes, mercaptosilanes, hydroxysilanes and ureidosilanes, such as γ-hydroxypropyl trimethoxysilane, γ-aminopropyl trimethoxysilane, 3-ureidopropyl triethoxysilane, y-mercaptopropyl trimethoxysilane, γ-glycidoxypropyl trimethoxysilane, β-(3,4-epoxycyclohexyl)trimethoxysilane, and N-β-(aminoethyl)-y-aminopropyl trimethoxysilane.

To produce the molding material mixture, the components of the binder system can first be combined, and then added to the basic refractory molding material. However, it is also possible to add the components of the binder simultaneously or successively to the basic refractory molding material.

To achieve a uniform mixture of the components of the molding material mixture, customary processes can be used. The molding material mixture can also contain other conventional constituents, such as iron oxide, ground flax fibers, sawdust granules, pitch and refractory metals, if applicable.

As a further subject matter, the invention relates to a method for producing a molded article, comprising the following steps:
preparing the above-described molding material mixture;
shaping the molding material mixture into a molded article;
curing the molded article by adding a curing catalyst.

To produce the molded article, the binder is first combined as described above with the basic refractory molding material to produce a molding material mixture. If the molded article will be produced by the PU no-bake method, a suitable catalyst can also be added to the molding material mixture. Preferably, liquid amines are also added to the molding material mixture. These amines preferably have a pK_{b} value of 4 to 11. Examples of suitable catalysts include 4-alkyl pyridines, wherein the alkyl group comprises 1 to 4 carbon atoms, isoquinoline, aryl pyridines, such as phenyl pyridine, pyridine, acryline, 2-methoxy pyridine, pyridazine, quinoline, n-methylimidazole, 4,4′-dipyridine, phenylpropyl pyridine, 1-methylbenzimidazole, 1,4-thiazine, N,N-dimethylbenzylamine, triethylamine, tribenzylamine, N,N-dimethyl-1,3-propanediamine, N,N-dimethylethanolamine and triethanolamine. The catalyst can be diluted, if necessary, with an inert solvent, for example, 2,2,4-trimethyl-1,3-pentanediol-diisobutyrate, or with a fatty acid ester. The quantity of catalyst added is chosen within the range of 0.1 to 15 wt %, referred to the weight of the polyol component.

The molding material mixture is then placed in a mold using customary means, and is compacted there. The molding material mixture is then cured to form a molded article. During curing, the molded article should preferably obtain its exterior shape.

According to a further preferred embodiment, curing is carried out according to the PU cold box method. For this purpose, a gaseous catalyst is conducted through the shaped molding material mixture. As the catalyst, catalysts customarily used for the cold box method can be used. Amines are particularly preferably used as the catalysts, particularly preferably dimethylethylamine, dimethyl-n-propylamine, dimethylisopropylamine, dimethyl-n-butylamine, triethylamine and trimethylamine, in gaseous form or as an aerosol.

The molded article produced by the method can have any form customary for the foundry industry. In one preferred embodiment, the molded article is in the form of casting molds or casting cores.

The invention further relates to a molded article, such as can be obtained with the above-described method. Said article is characterized by high mechanical stability and by low smoke development during metal casting.

The invention further relates to the use of this molded article for metal casting, particularly for iron and aluminum casting. In what follows the invention will be specified in greater detail in reference to preferred embodiments.

### EXAMPLES

1. Preparation of the Phenolic Resin

999.65 g of a mixture of phenol and paraformaldehyde (91%) having a molar formaldehyde/phenol ratio of 1.24:1 and 0.35 g zinc acetate dihydrate were placed in a reaction vessel equipped with a cooler, a thermometer and a stirrer. The cooler was set to reflux, the temperature was increased continuously to 108 to 112° C., and the reaction mixture was held at this temperature for 3.5 h. The cooler was then switched to atmospheric distillation and the temperature was increased continuously under distillation over a period of one hour to 124 to 126° C. This temperature was held for 30 minutes. The mixture was then distilled under a vacuum of 450 mbar for 5 minutes.
2. Preparation of the Phenolic Resin Solutions

The phenolic resin produced according to the above procedure was diluted with the constituents listed in Table 1 to the polyol component of the polyurethane binder system.

As the isocyanate component of the polyurethane binder system, a mixture of 80% industrial polymeric MDI and 20% light naphtha solvent was used.

TABLE 1

| | Not according to | | | | | | | | | | |
|---|---|---|---|---|---|---|---|---|---|---|---|
| | the invention | | According to the invention | | | | | | | | |
| Test | 1.1 | 1.2 | 1.3 | 1.4 | 1.5 | 1.6 | 1.7 | 1.8 | 1.9 | 1.10 | 1.11 |
| Phenolic resin | 53.0 | 48.0 | 53.0 | 53.0 | 53.0 | 53.0 | 53.0 | 48.0 | 48.0 | 48.0 | 48.0 |
| Isophorone | 7.8 | 8.6 | 6.9 | 6.1 | 5.3 | 6.9 | 6.1 | 7.8 | 6.9 | 7.8 | 6.9 |
| Light naphtha | 20.0 | 21.0 | 17.8 | 15.7 | 13.5 | 17.8 | 15.7 | 20.0 | 17.8 | 20.0 | 17.8 |
| solvent | | | | | | | | | | | |
| Phthalate | 15.7 | 17.4 | 14.0 | 12.3 | 10.6 | 14.0 | 12.3 | 15.7 | 14.0 | 15.7 | 14.0 |
| softening agent | | | | | | | | | | | |
| Tall oil fatty acid | 3.0 | 4.5 | 2.7 | 2.4 | 2.1 | 2.7 | 2.4 | 3.0 | 2.7 | 3.0 | 2.7 |
| butyl ester | | | | | | | | | | | |
| Silane | 0.5 | 0.5 | 0.5 | 0.5 | 0.5 | 0.5 | 0.5 | 0.5 | 0.5 | 0.5 | 0.5 |
| Polyol CTF ^{a)} | — | — | 5.0 | 10.0 | 15.0 | — | — | 5.0 | 10.0 | — | — |
| Polyol TD ^{b)} | — | — | — | — | — | 5.0 | 10.0 | — | — | 5.0 | 10.0 |

^{a)} Polyol CTF, 5-ethyl-5-hyroxymethyl-1,3-dioxane (Perstorp Specialty Chemicals AB)
^{b)} Polyol TD, polyol mixture containing 5-ethyl-5-hydroxymethyl-1,3-dioxane (Perstorp Specialty Chemicals AB)

3. Preparation of the Test Bar and Determination of Bending Strength in the Polyurethane Cold Box Method

0.8 wt % each of the phenolic resin solutions listed in Table 1 and the polyisocyanate component (part 2) were added in succession to 100 parts by weight quartz sand H 32 (Quarzwerke Frechen) and were vigorously mixed in a laboratory mixer (Vogel and Schemmann AG). After the mixture had been mixed for 2 minutes, the molding material mixtures were transferred to the reservoir of a core shooting machine (Roperwerke Giessereimaschinen GmbH) and were introduced into the mold using compressed air (4 bar). The molded articles were cured by gasing with 1 ml triethylamine (2 sec., 2 bar pressure, then 10 sec. flushing with air). As test articles, rectangular test bars measuring 220 mm×22.36 mm×22.36 mm, so-called Georg-Fischer test bars, were produced. To determine bending strength, the test bars were placed in a Georg-Fischer strength testing device, equipped with a three-point bending device (Simpson Technologies GmbH), and the force that resulted in cracking of the test bars was measured. The bending strength levels are listed in Table 2.

TABLE 2

| | Strength levels [N/cm²] | | | | | | | | | | |
|---|---|---|---|---|---|---|---|---|---|---|---|
| | Not according to | | | | | | | | | | |
| | the invention | | According to the invention | | | | | | | | |
| Test | 1.1 | 1.2 | 1.3 | 1.4 | 1.5 | 1.6 | 1.7 | 1.8 | 1.9 | 1.10 | 1.11 |
| Immediate | 180 | 115 | 210 | 205 | 200 | 215 | 200 | 160 | 180 | 160 | 180 |
| 0.5 h | 400 | 330 | 440 | 410 | 410 | 440 | 410 | 380 | 410 | 410 | 420 |
| 1 h | 420 | 380 | 460 | 450 | 420 | 460 | 440 | 430 | 490 | 430 | 430 |
| 2 h | 450 | 390 | 470 | 460 | 460 | 465 | 460 | 435 | 490 | 430 | 430 |
| 24 h | 540 | 470 | 590 | 580 | 560 | | | | | | |

It is clear from Table 2 that the use of cyclic formals increases strength. The relative increase in strength is particularly high with formulations that have a reduced content of phenolic resin in part I (cf., 1.2 relative to 1.8 through 1.11).
4. Preparation of the Test Bars and Determination of Bending Strength in the Polyurethane No-Bake Method

The polyol components listed in Table 1 can also be cured using the polyurethane no-bake method. This method differs from the cold box method in that curing of the molding material mixtures is catalyzed not by gasing with a volatile amine but by adding a liquid catalyst. Said catalyst can be dissolved in advance in the polyol component, for example, or can be added to the molding material mixture during the mixing process. And molding generally is not performed with the help of core shooting machines, but by simply filling the molds and then compacting the mixture by hand or by shaking. As examples of the polyurethane no-bake method, polyol components 1.1, 1.3 and 1.8 were used, to each of which 0.8 wt % 4-phenylpropylpyridine was then added prior to preparation of the molding material.

The values found with the stated mixtures are listed in Table 3

TABLE 3

| | |
|---|---|
| Not according to the | According to |
| invention | the invention |

| | | | |
|---|---|---|---|
| Test | 1.1 | 1.3 | 1.8 |
| Processing time [min.]^{a)} | 3 | 5 | 5 |
| Stripping time [min.]^{b)} | 7 | 8 | 7 |
| Strength levels [N/cm²] | | | |
| 0.5 h | 230 | 230 | 215 |
| 1 h | 295 | 275 | 280 |
| 2 h | 330 | 325 | 325 |
| 24 h | 420 | 460 | 400 |

^{a)}Time available for compacting the molding material mixture
^{b)}Time after which the core is stable enough that it can be removed from the mold

In the polyurethane no-bake method, it is clear that the cyclic formal extends processing times, while maintaining the good strength levels, wherein stripping times are not changed or are only slightly changed. In many cases this is favorable, since when producing large molds and cores, more time is available for compacting the molding material mixtures well.

1. A binder for molding material mixtures, comprising:
at least one phenolic resin component as a polyol component comprising a phenolic resin resulting from reacting a phenol compound with an aldehyde compound;
at least one isocyanate component having at least one polyisocyanate with at least two NCO groups per molecule; and
at least one solvent component comprising a cyclic formal of the following formula: 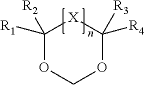
wherein
X denotes —C(R₅)(R₆)— or —R₇O—R₈—
n denotes 0 to 4 and
R₁ to R₆ independently denote H, a hydrocarbon group, or a substituted hydrocarbon group, wherein the substituted hydrocarbon group contains at least one of an ether group and an ester group and/or is substituted with at least one of a carbonyl group and a hydroxyl group, and
R₇ and R₈ independently denote a methylene, ethylene or propylene group, or the at least one solvent component is selected from the group consisting of: 1,4-butanediol formal, glycerin formal, ethylene glycol formal, propylene glycol formal, 1,2-butanediol formal and mixtures thereof.

2. The binder according to claim 1, wherein the cyclic formal is chosen from the group consisting of: 1,3-butanediol formal, 1,4-butanediol formal, glycerin formal, 5-ethyl-5-hydroxymethyl-1,3-dioxane and mixtures thereof.

3. The binder according to claim 1, wherein the cyclic formal is 5-ethyl-5-hydroxymethyl-1,3-dioxane.

4. The binder according to claim 1, wherein the polyisocyanate is an aromatic polyisocyanate.

5. The binder according to claim 1, wherein the polyisocyanate is polymethylene polyphenyl polyisocyanate.

6. The binder according to claim 1, wherein the phenolic resin is formed in a weakly acidic medium using transition metal catalysts.

7. The binder according to claim 6, wherein the catalyst is a zinc compound.

8. The binder according to claim 1, wherein the phenolic resin is a benzyl ether resin.

9. The binder according to claim 1, wherein the phenol compound is chosen from the group consisting of: phenol, o-cresol, p-cresol, bisphenol A, cardanol and mixtures therof.

10. The binder according to claim 1, wherein the aldehyde compound is an aldehyde of the formula:
R—CHO,
wherein R denotes a hydrogen atom or a carbon group having from 1 to 8 carbon atoms.

11. The binder according to claim 1, wherein the components comprising the binder are:
the phenolic resin component is in the range of 15 to 35 wt %;
the isocyanate component is in the range of 25 to 45 wt %; and
the solvent component is in the range of 20 to 60 wt %.

12. The binder according to claim 1, wherein the entire binder contains up to 0.25 to 20 wt % cyclic formals.

13. The binder according to claim 12, wherein the solvent component includes compounds selected from the group consisting of: aromatic hydrocarbons, esters, ketones, cyclic acetals and mixtures thereof.

14. A molding material mixture, comprising:
the binder according to claim 1; and
a refractory molding material.

15. A method for producing a cast molding piece or a core, comprising the steps of:
combining refractory materials with the binder system according to claim 1 in a binding quantity of 0.2 to 5 wt %, referred to the quantity of refractory materials, to obtain a casting mixture;
introducing the casting mixture into a mold;
hardening the casting mixture in the mold to obtain a self-supporting form; and
then separating the hardened cast material piece from the mold and hardening said piece further, if necessary, whereby a solid, cured molded cast piece is obtained.

16. The method according to claim 15, wherein:
the hardening step is achieved using a curing catalyst, in a gaseous or aerosol form, selected from the group consisting of: dimethylethylamine, dimethyl-n-propylamine, dimethylisopropylamine, dimethyl-n-butylamine, triethylamine, trimethylamine, and mixtures thereof.

17. The method according to claim 15, wherein:
the hardening step is achieved using phenylpropyl pyridine as a liquid catalyst.

18. The binder according to claim 1, wherein the hydrocarbon group or substituted hydrocarbon group is an alkyl group having 1 to 6 carbon atoms.
